(19) United States
(12) Patent Application Publication
(10) Pub. No.: US 2026/0061355 A1
(43) Pub. Date: Mar. 5, 2026

(54) FILTER MEDIA

(71) Applicant: Dyson Technology Limited, Malmesbury, Wiltshire (GB)

(72) Inventors: Samuel Henry George JACKSON, Christchurch (NZ); Ignacio Justo PEREZ PABLOS, Malmesbury (GB); Gareth David Morte MORRIS, Bristol (GB); Andrea RICCI, Bristol (GB)

(21) Appl. No.: 19/106,660

(22) PCT Filed: Aug. 8, 2023
(86) PCT No.: PCT/IB2023/057993

§ 371 Date: Feb. 26, 2025

(30) Foreign Application Priority Data
Aug. 26, 2022 (GB) 2212428.3

(51) Int. Cl. B01D 46/54; A47L 9/12; B01D 46/52

(52) U.S. Cl. CPC B01D 46/543; A47L 9/12; B01D 46/521; B01D 2239/0627; B01D 2239/0668; B01D 2279/55

(57) ABSTRACT

Described herein is a filter media that can have a membrane layer and a first non-woven scrim layer that is secured to a surface of the membrane layer. The filter media can have a Young's Modulus of at least 175 MPa. Also described is an air filtering device with an inlet, an airflow generator to generate an airflow from the inlet towards the airflow generator, and the filter media.

### TECHNICAL FIELD

The present invention relates to a filter media, and to an air filtration device comprising the filter media.

### BACKGROUND

Air filtration devices output noise during use. For some air filtration devices, such as vacuum cleaners, there are maximum legal noise limits that a device may output, which can limit the achievable performance of the vacuum cleaner. For vacuum cleaners, or for other air filtration devices such as environmental control devices, it may be desirable that devices be as quiet as possible so as not to disturb people in the vicinity of the device, whilst providing, for example improved air quality.

### SUMMARY OF THE INVENTION

According to a first aspect of the invention, there is disclosed a filter media comprising a membrane layer and a first non-woven scrim layer secured to a surface of the membrane layer, the filter media having a Young's Modulus of at least 175 MPa.

Typical filter media, for example as used in air filtration devices, are thin and have very low stiffness, which allows acoustic energy to transmit easily through the filter media, greatly reducing observed acoustic attenuation. It has been found that increasing the stiffness and structural damping of a typical filter media by increasing the Young's Modulus of the filter media may increase the acoustic attenuation properties of the filter media.

A Young's Modulus of at least 175 MPa may provide an improvement in acoustic attenuation without unduly impacting flow resistivity or filtration efficiency of the filter media, compared to a filter media with a lower Young's Modulus.

The Young's Modulus of the filter media may be determined by subjecting the filter media to a tensile load and calculating the Young's Modulus from the initial linear part of the resultant stress-strain curve. The Young's Modulus may be calculated with the filter media in sheet form, for example with the filter media in an unpleated configuration.

The filter media may be in a pleated configuration, which can increase the stiffness of the filter media compared to an unpleated configuration.

The scrim layer may be a spunbonded layer.

The filter media may have an areal density of at least 30 g·m⁻², for example between 30 and 210 g·m⁻². The filter media may have a flow resistivity of no more than 12,000,000 Ns·m⁻⁴, for example between 5,000,00 and 12,000,000 Ns·m⁻⁴. The filter media may have an air permeability at 125 Pa of at least 69 l·m⁻²·s⁻¹, for example between 69 and 167 l·m⁻²·s⁻¹. The filter media may have a volume density of at least 150 kg·m⁻³, for example between 150 and 300 kg·m⁻³. The filter media may have a thickness of no more than 0.3 mm, for example a thickness of no more than 0.15 mm. Such characteristics of the filter media may provide beneficial filtration and acoustic attenuation performance, for example when the filter media is for use in an air filtering device.

The filter media may have a Young's Modulus of at least 300 MPa. Providing a filter media having a Young's Modulus over 300 MPa may provide greater noise attenuation than filter media having a lower Young's Modulus.

The first non-woven scrim layer may comprise expanded polytetrafluoroethylene (ePTFE). ePTFE may provide good acoustic attenuation and filtration properties.

The filter media may comprise a second non-woven scrim layer secured to an opposing side of the membrane layer to the first non-woven scrim layer. Providing a second non-woven scrim layer to an opposing side of the membrane can allow thinner first and second scrim layers to be employed to achieve the required Young's Modulus, compared to having only one scrim layer.

The second non-woven scrim layer may have any of the features discussed with reference to the first non-woven scrim layer.

The filter media may comprise plural membranes sandwiched between non-woven scrim layers. This may increase the Young's Modulus of the filter media and thus acoustic attenuation performance, but must be balanced with a resulting increase in flow resistivity.

According to a second aspect of the invention, there is disclosed an air filtering device comprising an inlet, an airflow generator to generate an airflow from the inlet towards the airflow generator, and a filter media according to the first aspect of the present invention to filter the airflow.

Airflow generators typically produce a majority of noise generated by an air filtering device in use. By providing a filter media according to the first aspect of the present invention, the filter media provides the dual purpose of filtration of the airflow and acoustic attenuation to increase acoustic transmission loss across the filter media. The noise of the airflow generator may thus be attenuated by a greater degree than in typical air filtering devices employing a filter media that is not according to the first aspect of the present invention. In turn, the airflow generator may be operable at greater speeds whilst remaining below an acoustic threshold. Provision of the filter media according to the first aspect of the invention may negate or reduce a need for other components to attenuate noise, such as insulation.

The filter media may be pleated. Pleating the filter media can help to smooth acoustic attenuation across a broad range of acoustic frequencies, which can help to eliminate elastic mode effects on transmission loss through the filter media. Additionally, a pleated filter media has a greater surface area than a planar, sheet-like filter media for a given available space, for example within an air filtering device, which can improve filtration performance.

The pleated filter media may be arranged in a cylindrical form. The pleats may extend parallel to a longitudinal axis of the cylindrical filter media, which may increase the overall stiffness of the filter media in a direction parallel to the longitudinal axis.

The filter media may be positioned downstream of the airflow generator. Provision of the filter media downstream of the airflow generator may enable filtering of airflow post-the airflow generator e.g., to remove fine particulates from the airflow prior to airflow being ejected from the air filtering device to an ambient environment in which the air filtering device is being used, whilst also reducing noise transmission to the ambient environment. Alternatively, the filter media may be positioned upstream of the airflow generator.

The air filtering device may be a vacuum cleaner or an air purifier. Such devices are often legally limited with regard to permitted noise output, which can limit the performance of the device, for example as a result of the airflow generator being required to run at lower speeds to reduce generated noise. By increasing acoustic attenuation, performance of such devices may be increased without exceeding the legal limits, for example with the airflow generator able to run at higher speeds for a given noise level.

### BRIEF DESCRIPTION OF THE DRAWINGS

Examples will now be described with reference to the accompanying drawings, in which:

FIG. 1 is an end view of a filter media according to an example;

FIG. 2 is a diagram showing transmission of an incident sound through a filter in an elastic mode;

FIG. 3 is a diagram showing transmission of an incident sounds through a filter in a non-elastic mode;

FIG. 4 is a graph showing transmission loss against acoustic frequency for different pleated filter media;

FIG. 5 is a perspective view of a vacuum cleaner according to an example; and

FIG. 6 is a perspective view a filter assembly comprising a filter media according to an example.

### DETAILED DESCRIPTION

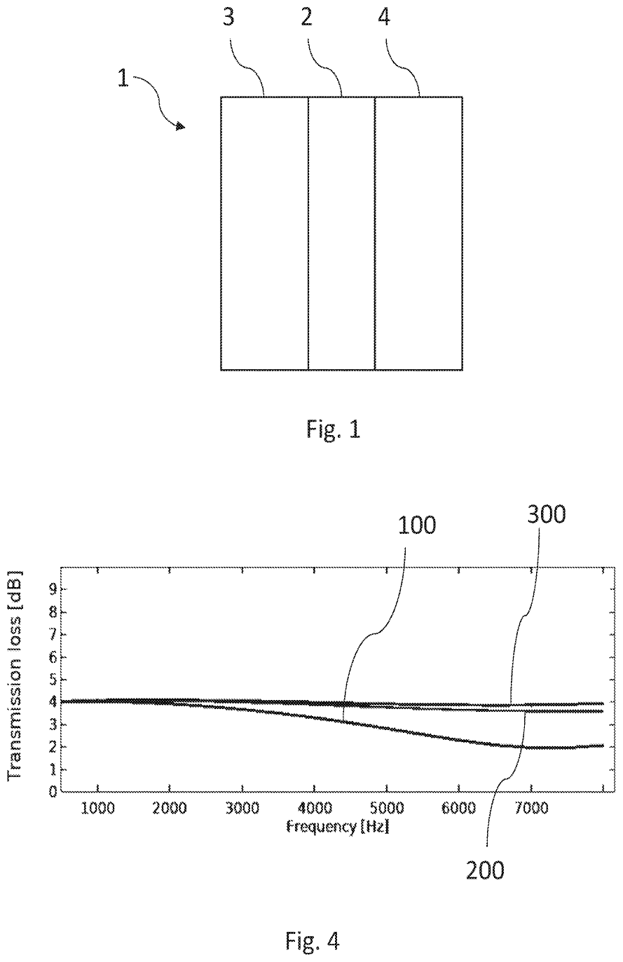

The filter media 1 of FIG. 1 comprises a membrane 2, a first protective scrim layer 3 and a second protective scrim layer 4. The filter media 1 is pleated with a pleat depth of around 6.5 mm. The filter media 1 is primarily provided to provide air filtration. It has been found that providing a filter media having a Young's Modulus of at least 175 MPa may provide an improvement in acoustic attenuation compared to filter media with a lower Young's Modulus. The filter media 1 has a Young's Modulus, also known as elastic modulus, of around 300 MPa. This is greater than typical air filtration filter media. This increased Young's Modulus increases the acoustic attenuation of the filter media 1 without significantly increasing the pressure drop or restriction over the filter media 1.

The membrane 1 is formed of fibres of expanded polytetrafluoroethylene (ePTFE), which is particularly advantageous in terms of filtration performance relative to the thickness and weight of the membrane 1. In other examples, the membrane 1 may be formed from nanofibers.

The filter media 1 has a thickness of around 0.15 mm. Alternative thicknesses are possible. For example, a thinner filter media may have the benefit of requiring less space and providing a smaller pressure drop, but acoustic attenuation performance may worsen. A thicker filter media may provide better filtration and acoustic attenuation performance, but in the pleated configuration may have a smaller surface area for filtration. In this example, the protective scrim layers 3, 4 have substantially equal thicknesses of approximately 0.17 mm, and the membrane 2 has a smaller thickness than the protective scrim layers 3, 4.

The filter media 1 has an areal density of around 40 g·m⁻². Alternative areal weights are possible. For example, a lower areal weight may have the benefit of providing a larger open area and thus a smaller pressure drop. However, the protection provided by the scrim layers 3, 4 is likely to worsen. A higher areal weight may afford greater protection to the membrane 2, but a greater restriction of airflow moving through the filter media 1 and thus a higher pressure drop. A balance is required between the competing factors of protection and pressure drop. The filter media has a flow resistivity of around 8,000,000 Ns·m⁻⁴, a volume density of around 185 kg/m³ and an air permeability at 125 Pa of around 90 l·m⁻²·s⁻¹. Such parameters have found to help balance the competing factors of protection and pressure drop.

The protective scrim layers 3, 4 are spunbonded non-woven layers secured to the membrane 2 by thermal bonding. Alternative methods of securing may equally be used, for example, adhesive or ultrasonic welding. Spunbonded layers provide acceptable filtration performance whilst protecting the membrane 2. In this example, the filter media 1 is formed from expanded polytetrafluoroethylene. In other examples, alternative suitable materials may be employed. In other examples, the first protective scrim layer 3 is formed from a different material to the second protective scrim layer 4.

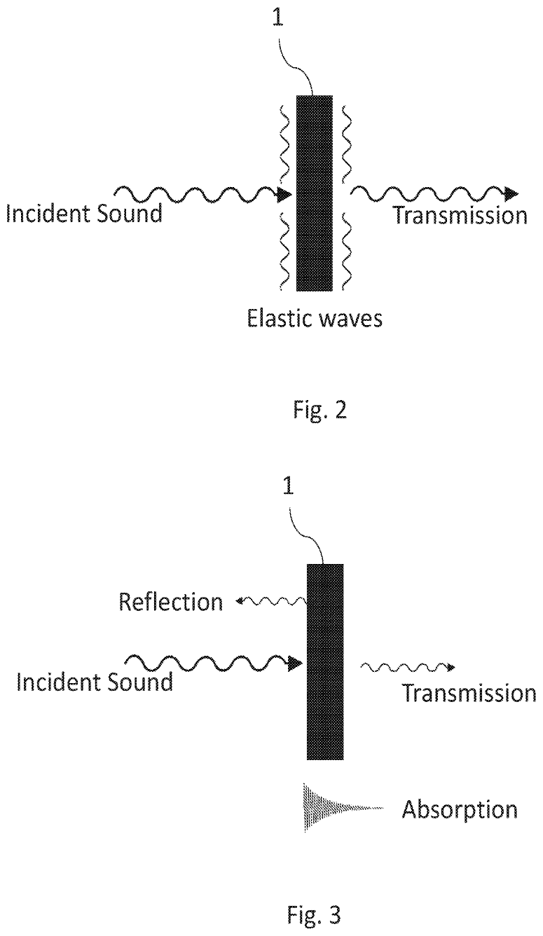

FIG. 2 shows diagrammatically the acoustic attenuation effects of a filter media when the filter media is in an elastic mode, for example at a resonant frequency of the filter media. Elastic waves propagate through the filter media, which significantly reduces acoustic absorption by the filter media; substantially all of the incident sound is transmitted through the filter media.

In contrast, FIG. 3 shows diagrammatically the acoustic attenuation effects of a filter media when the filter media is not in an elastic mode. Acoustic absorption is significantly increased compared to when in an elastic mode, such that a relatively small proportion of the incident sound is transmitted through the filter media and reflected by the filter media. It has been found that changing the pleat depth of a filter media can affect the frequencies at which an elastic mode occurs.

FIG. 4 depicts modelled acoustic transmission loss through three pleated filter medias formed from ePTFE and pleated with a pleat depth of 6.5 mm, and subjected to acoustic frequencies up to 8 kHz. The filter medias are substantially similar in terms of surface area and thickness, but have differing Young's Moduli: around 150 MPa (line 100), around 450 MPa (Line 200) and around 1500 MPa (line 300). Increasing the Young's Modulus of the filter media causes transmission loss through the filter media to become more stable across the range of frequencies shown.

At frequencies above around 3,000 Hz, transmission loss through the filter medias with a higher Young's Modulus is greater than transmission loss through the filter media with a Young's Modulus of around 150 MPa. The difference in transmission loss becomes more pronounced at higher frequencies (4-8 kHz in this example), which may be more likely to occur during use of an air filtering device than lower frequencies. FIG. 4 suggests that increasing the Young's Modulus of the filter media 1 further, for example above 450 MPa, may provide diminishing returns with respect to acoustic attenuation benefits.

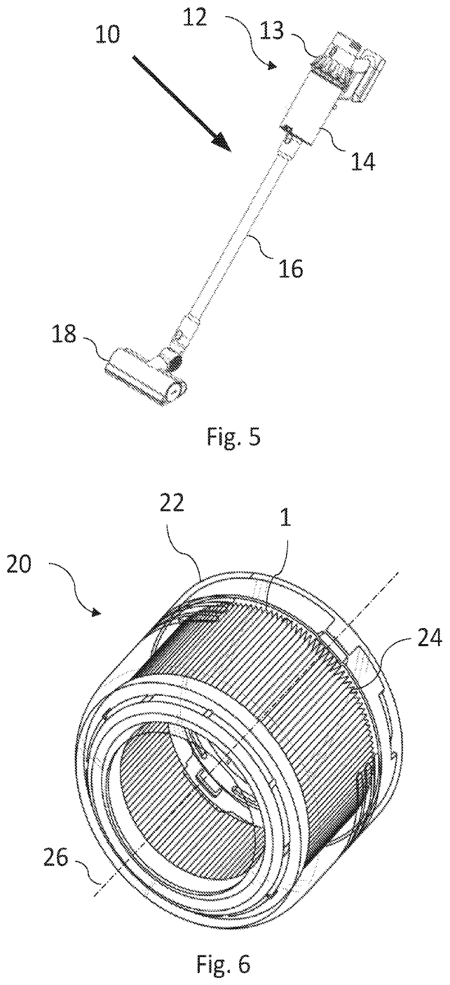

The filter media 1 is for use in a vacuum cleaner 10, as shown in FIG. 5, but may be equally employed in other air filtering devices such as an air purifier. The filter media 1 is positioned in the vacuum cleaner 10 downstream of an airflow generator (not shown), which in this example comprises an electric motor. The vacuum cleaner 10 comprises a main body 12 that houses the airflow generator, the filter media 1 and a dirt separator 14. A wand 16 is attached to the main body 12 and comprises a cleaner head 18 at a distal end of the wand 16 to the main body 12. In use, the airflow generator generates an airflow that passes from the cleaner head 18, through the dirt separator 14 and through the filter media 1, before being expelled from the main body 12 via an outlet 13. The filter media 1 removes fine particles from the airflow whilst also reducing noise transmission to the ambient environment.

When installed in the vacuum cleaner 10, the filter media 1 is in a pleated configuration and arranged in a cylindrical form, as best shown in FIG. 6. The filter media 1 is held within a frame 22 of a filter assembly 20. Providing a pleated filter media 1 can increase the surface area of the filter media 1 for a given volume, which in turn can improve filtration performance when in use in an air filtering device. Further, as discussed with reference to FIG. 4, providing a pleated filter media 1 may reduce the effects of elastic modes of the filter media 1 on transmission loss. Pleats 24 in the filter media 1 extend parallel to a longitudinal axis 26 of the filter assembly 20, which may increase the stiffness of the filter media 1 in a direction parallel to the longitudinal axis 26 compared to other orientations of the pleats 24.

The vacuum cleaner 10 is operable in a mode in which a generated acoustic frequency is at least 4 kHz. As discussed with reference to FIG. 4, the acoustic attenuation benefits of a pleated filter media with a higher Young's Modulus may be more noticeable at such frequencies.

In further examples, the filter media comprises only one protective scrim layer secured to the membrane. When assembled in a vacuum cleaner, the protective scrim layer is secured to an upstream side of the membrane to protect the membrane from debris entrained in airflow passing through the filter media. Providing only one protective scrim layer may provide a less complex filter media, but may require a thicker protective scrim layer to achieve the required Young's Modulus of at least 175 MPa.

In still further examples, the filter media comprises at least two membranes each sandwiched between protective scrim layers. This may provide a stiffer filter media and/or may enable thinner layers to be employed to achieve the required Young's Modulus of at least 175 MPa.

The above embodiments are to be understood as illustrative examples of the invention. Further embodiments of the invention are envisaged. For example, the filter media may not be pleated. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A filter media comprising a membrane layer and a first non-woven scrim layer secured to a surface of the membrane layer, the filter media having a Young's Modulus of at least 175 MPa.

2. The filter media according to claim 1, wherein the filter media has a Young's Modulus of at least 300 MPa.

3. The filter media according to claim 1, comprising a second non-woven scrim layer secured to an opposing side of the membrane layer to the first non-woven scrim layer.

4. An air filtering device, comprising:
an inlet;
an airflow generator to generate an airflow from the inlet towards the airflow generator; and
a filter media comprising a membrane layer and a first non-woven scrim layer secured to a surface of the membrane layer, the filter media having a Young's Modulus of at least 175 MPa to filter the airflow.

5. The air filtering device according to claim 4, wherein the filter media is pleated.

6. The air filtering device according to claim 4, wherein the filter media is downstream of the airflow generator.

7. The air filtering device according to claim 4, wherein the air filtering device is a vacuum cleaner.
